(19) United States
(12) Patent Application Publication
(10) Pub. No.: US 2020/0334769 A1
(43) Pub. Date: Oct. 22, 2020

(54) DYNAMIC SIGNAGE FOR ELECTRONIC MENU BOARD

(71) Applicant: The Coca-Cola Company, Atlanta, GA (US)

(72) Inventors: William Michael Koehler, Alpharetta, GA (US); Phillip Mark Isaacs, Atlanta, GA (US); Gregory Lee Chambers, Santa Monica, CA (US); Elen Erzhibova, Lawrenceville, GA (US)

(21) Appl. No.: 16/854,127

(22) Filed: Apr. 21, 2020

Related U.S. Application Data
(60) Provisional application No. 62/836,958, filed on Apr. 22, 2019.

(51) Int. Cl. G06Q 50/12; G06Q 30/02; G07C 9/38; G06F 3/147; G09F 13/00

(52) U.S. Cl. CPC G06Q 50/12; G06Q 30/0201; G06Q 30/0205; G09F 13/005; G07C 9/38; G06F 3/147; G06Q 30/0254

(57) ABSTRACT

A method implemented on a dongle device for controlling menu board items on an attached display device includes receiving content for a menu board from an electronic computing device. The menu board content is transferred to the display device for display on the display device. Information is received regarding sales of items listed on the menu board. The information identifies purchasing trends for the items listed on the menu board. A display of the menu board items is dynamically updated based on the identified purchasing trends.

### BACKGROUND

Menu boards permit customers of restaurants, particularly quick service restaurants, to view food items offered for sale. Traditional menu boards have static items, such as chalkboards or framed backboards that can mount changeable letters and numbers. Changing content and pricing on traditional letter boards typically require a human to physically change the content and prices, for example by writing new content or pricing on a chalkboard, or by physically manipulating the changeable letters and numbers.

Many quick service restaurants have recently adopted electronic menu boards. With electronic menu boards, the content and pricing can be changed using an electronic device, typically a desktop or laptop computer. Communication between the electronic device and the electronic menu board is typically performed locally in the quick service restaurant.

### SUMMARY

Embodiments of the disclosure are directed to a method implemented on a dongle device for controlling menu board items on an attached display device. The method comprises: on the dongle device, receiving content for a menu board from an electronic computing device; transferring the menu board content to the display device for display on the display device; receiving information regarding sales of items listed on the menu board, the information identifying purchasing trends for the items listed on the menu board; and dynamically updating a display of the menu board items based on the identified purchasing trends.

In another aspect, a dongle device comprises: a processor; and system memory, the system memory including instructions which, when executed by the processor, cause the dongle device to: receive signage for an electronic menu board from a server computer, the signage including textual and graphic content, the electronic menu board being operational in a restaurant; transfer the signage to a display device attached to the dongle device for display on the display device; receive statistical data regarding sales of the items listed on the electronic menu board; identify purchasing trends from the statistical data regarding the sales of the items listed on the electronic menu board; receive a geographical location of the restaurant; and dynamically update a display of the electronic menu board items based on the identified purchasing trends and the geographical location of the restaurant.

In yet another aspect, dongle device comprises: a processor; and system memory, the system memory including instructions which, when executed by the processing unit, cause the dongle device to: receive signage for an electronic menu board from a server computer, the signage including textual, graphic, and video content, the electronic menu board being operational in a quick service restaurant; transfer the signage to a display device attached to the dongle device for display on the display device; receive, from the server computer, statistical data regarding sales of the items listed on the electronic menu board, the statistical data including a number of units sold and a monetary amount of sales by day and hour for each item listed on the electronic menu board; identify purchasing trends from the statistical data regarding the sales of the items listed on the electronic menu board, the purchasing trends identifying best-selling items, slowest-selling items, spikes in purchasing, and lulls in purchasing; receive from the server computer an advertisement for a slow-selling item; receive a geographical location of the restaurant; and dynamically update a display of the electronic menu board items based on the identified purchasing trends and the geographical location of the quick service restaurant, including adding to the electronic menu board the advertisement for the slow-selling item.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports dynamic signage for an electronic menu board.

FIG. 2 shows example modules of a dongle device of the system of FIG. 1.

FIG. 3 shows example modules of a server computing device of the system of FIG. 1.

FIG. 4 shows example modules of a mobile electronic computing device of the system of FIG. 1.

FIG. 5 shows an example display screen of an electronic menu board of the system of FIG. 1.

FIG. 6 shows another example display screen of the electronic menu board of the system of FIG. 1.

FIG. 7 shows yet another example display screen of the electronic menu board of the system of FIG. 1.

FIG. 8 shows yet another example display screen of the electronic menu board of the system of FIG. 1.

FIG. 9 shows an example graphical user interface of the mobile electronic computing device of the system of FIG. 1.

FIG. 10 shows another example graphical user interface of the mobile electronic computing device of the system of FIG. 1.

FIG. 11 shows yet another example graphical user interface of the mobile electronic computing device of the system of FIG. 1.

FIG. 12 shows an example method for setting up the system of FIG. 1.

FIG. 13 shows an example method for using the system of FIG. 1.

FIG. 14 shows example physical components of the dongle device of the system of FIG. 1.

### DETAILED DESCRIPTION

The present disclosure is directed to systems and methods for permitting electronic menu board signage to be created and updated from a mobile electronic computing device, such as a smartphone.

Signage information is sent from the smartphone to another electronic computing device, typically a server computer, over an electronic network, such as the Internet, using a wireless (WiFi) connection. The signage information is then downloaded to the electronic menu board from the server computer. In this manner, the electronic menu board can display signage, and updates to the signage, from the smartphone, quickly, in near real-time.

As used in this disclosure, signage comprises text, photographs, graphics, sounds and/or video content that can be rendered on the electronic menu board.

The electronic menu board comprises one or more display devices that can display the menu signage. A dongle is physically connected to each display device. The dongle maintains a WiFi connection with the server computer, receives the menu signage, and organizes the menu signage on each respective display device.

As used in this disclosure, the dongle is an electronic computing device that includes wireless functionality and that can be physically plugged into a display device or connected to the display device via an extension cable. The dongle includes memory and the ability to execute software applications. An example of a dongle that can be used with the display device is Google Chromebit, from Asus (AsusTek Computer Inc.), Taipei, Taiwan.

In the present disclosure, as discussed in detail later herein, the dongle can run a proprietary software application that can obtain menu board signage from a remote computer. In addition to providing and organizing the signage for the display device to which the dongle is attached, the proprietary software application can receive data from the server computer regarding a volume and monetary amount of menu items purchased at a restaurant, typically a quick service restaurant. The proprietary software application can analyze the data, perform a trend analysis of the data, and dynamically adjust the signage on the electronic menu board based on the trend analysis.

The dongle can also communicate with the smartphone using a short-range communication protocol such as Bluetooth. For example, as discussed later herein, the smartphone can setup a WiFi connection to the server computer via Bluetooth. In addition, the dongle can communicate via Bluetooth with a smartphone of a customer who enters the restaurant. As discussed in more detail later herein, the smartphone can deliver personalized messages to the customer's smartphone. For example, a message can offer a coupon or a discount to the customer for purchasing a specific menu item.

As used in the present disclosure, menu board content comprises the food items and prices listed on the electronic menu board. Also, as stated earlier herein, menu board signage, in addition to the content, includes any graphics or videos used on the electronic menu board. Menu board graphics can comprise photos of specific menu items. Each photo is typically placed near each respective menu item. Videos can comprise a video of a menu item, for example a video of a soft drink being poured into a glass. Videos can also comprise an advertisement for one or more of the menu items that can be shown on the electronic menu board. In addition, videos and/or graphics can be used in any excess space on the electronic menu board to advertise any product, including products not listed on the electronic menu board. In this disclosure, the systems and methods are discussed for an implementation in a quick service restaurant, although the systems and methods can be used in other types of restaurants.

The systems and methods discussed herein are directed to a computing technology that can permit wireless signage updates to an electronic menu board from a mobile electronic computing device, such as a smartphone. The use of a dongle device that connects to the a display device for the electronic menu board facilitates the wireless connection, allows intelligence for the display device to reside on the dongle device, and can obviate a need for a purchase of a more advanced display device. In addition, the systems and methods permit the dongle device to receive and analyze purchasing data for the electronic menu board and automatically and dynamically adjust the signage on the electronic menu board based on the analysis of the purchasing data.

The systems and methods also permit the dynamic and automatic updates of graphics, videos and advertisements to the electronic menu board based on the analysis of the purchasing data. Graphics, videos and advertisements can be added to the electronic menu board, or substituted for existing signage on the electronic menu board. The dynamic updates to electronic menu board signage, in conjunction with a dynamic analysis of purchasing trends, can in effect facilitate a dynamic feedback loop, wherein changes to correct negative purchasing trends can be iteratively adjusted to provide more positive purchasing results.

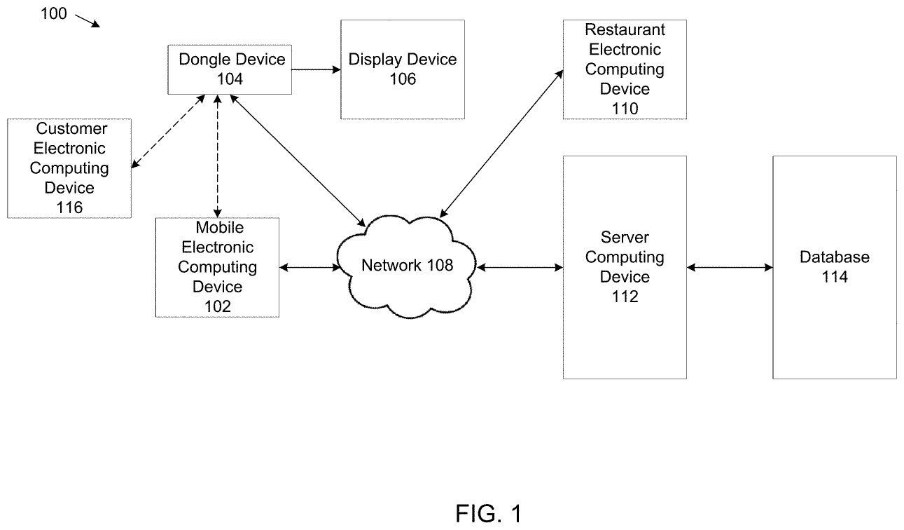

FIG. 1 shows an example system 100 that can support dynamic updates to an electronic menu board. System 100 includes a mobile electronic computing device 102, a dongle device 104, a display device 106, a network 108, a restaurant electronic computing device 110, a server computing device 112, a database 114, and a customer electronic computing device 116. More, fewer, or different components can be used.

The example mobile electronic computing device 102 is an electronic computing device of an employee or owner of the quick service restaurant. The electronic computing device is typically a smartphone, although a tablet or laptop computer can also be used. Other electronic computing devices are possible. Mobile electronic computing device 102 can include global positioning system (GPS) software that can provide a current geolocation of mobile electronic computing device 102.

The example dongle device 104 is an electronic device that can be physically connected to display device 106, either directly or via an extension cable. Dongle device 104 includes support for wireless connectivity, such as WiFi and Bluetooth. Dongle device 104 can also host an operating system and software applications. In the present implementation, dongle device 104 hosts a proprietary software application that permits organization and control of electronic menu board items.

The example display device 106 is a digital electronic display device that can display electronic menu board signage. The display device 106 receives the menu signage via dongle device 104. In a typical implementation, a plurality of display devices 106 are used. The display devices 106 are typically mounted contiguously, side by side, each display device 106 displaying a portion of the electronic menu board signage. In one example implementation, display devices 106 can be connected together so that a single dongle device 104 can control all of the display devices 106. In another example implementation, each display device 106 can have its own dedicated dongle device 104.

The example network 108 is a computer network and can be any type of wireless network, wired network and cellular network, including the Internet. Mobile electronic computing device 102 and restaurant electronic computing device 110 can communicate with server computing device 112 using network 108.

The example restaurant electronic computing device 110 is an electronic computing device of the quick service restaurant. Restaurant electronic computing device 110 can store or provide statistical information regarding items ordered from the electronic menu board during specific time periods. The statistical information can be used by server computing device 112 and dongle device 104 to perform a trend analysis regarding traffic in the quick service restaurant and items ordered.

The example server computing device 112 is a server computing device of the quick service restaurant or of a business organization that owns the quick service restaurant. Server computing device 112 receives the menu board signage information from mobile electronic computing device 102, stores the menu board and signage information, typically on database 114, and provides the menu board signage information to dongle device 104 via WiFi. Server computing device 112 can also communicate with restaurant electronic computing device 110 to obtain statistical information regarding items ordered from the electronic menu board. In some implementations, server computing device 112 can perform a trend analysis for orders using the statistical information. In other implementations, server computing device 112 can send the statistical information to dongle device 104, and the proprietary software application on dongle device 104 can perform the trend analysis. As discussed in more detail later herein, the trend analysis can permit dongle device 104 to dynamically adjust or prioritize a display of menu board signage.

The example database 114 is a database associated with server computing device 112. Database 114 can store menu board signage information as well as other information, such as the statistical information regarding items ordered from the electronic menu board. Database 114 can be distributed over a plurality of databases. Server computing device 112 can be programmed to query (e.g., using Structured Query Language, SQL) database 114 to obtain the signage and statistical information. Database 114 can also be an unstructured database. Examples of an unstructured database platform are the Google Firebase Realtime Database and Google Cloud Firestore.

An example schema including, but not limited to, customer information stored in database 114 is shown below. More, fewer, or different fields are possible.
Restaurant Name the name of the quick service restaurant;
Restaurant ID a set of letters, numbers, or other symbol that uniquely identifies the quick service restaurant;
Restaurant address a street address for the quick service restaurant
Menu items listed a number representing a quantity of menu items listed on the electronic menu board
Menu item 1 a name of a first menu item
Menu item 1 group a menu group (combo, entrée, beverage, side) associated with the menu 1 item
Menu item 1 position a position of the menu item within the menu item 1 group
Menu item 1 price a listed price for menu item 1
Menu item 1 description a textual description of menu item 1
Menu item 1 graphic an identifier for a graphic (if any) associated with menu item 1
Menu item 1 video an identifier for a video (if any) associated with menu item 1
Menu item 1 sales data a pointer to sales data relating to menu item 1
. . .
Menu item n a name of the nth menu item
Menu item n group a menu group (combo, entrée, beverage, side) associated with the nth menu item
Menu item n position a position of the menu item within the menu item n group
Menu item n price a listed price for menu item n
Menu item n description a textual description of menu item n
Menu item n graphic an identifier for a graphic (if any) associated with menu item n
Menu item n video an identifier for a video (if any) associated with menu item n
Menu item n sales data a pointer to sales data relating to menu item n
Customer 1 name a name of a customer 1 of the quick service restaurant
Customer 1 profile a pointer to information regarding customer 1; information can include the customer's birthday, purchasing history, and coupon history.
. . .
Customer n name a name of a customer n of the quick service restaurant
Customer n profile a pointer to information regarding customer n;

The above schema permits the database to be queried for data such as sales for menu item 1.

As an example, the following messaging format can be used between the server computing device 112 and the database 114 to obtain sales data for a specific menu item, in this case menu item 1.

| | | | | |
|---|---|---|---|---|
| Sales Data | Menu Item 1 | Date | Start Time | End Time |

As an example, the database 114 can use the following messaging format in responding to such a request. In this example, a quantity and monetary value of sales for menu item 1 for the specified time period are returned.

| | | |
|---|---|---|
| Menu Item 1 | number of units sold | dollar amount |

As another example, the following messaging format can be used between the server computing device 112 and the database 114 to identify a best-selling menu item during a specified time interval.

| | | | | |
|---|---|---|---|---|
| Sales Data | Best Seller | Date | Start Time | End Time |

As an example, the database 114 can use the following messaging format in responding to such a request. In this example, a dollar amount for the system recommended dollar amount for housing is returned in response to the request.

| | | | |
|---|---|---|---|
| Sales Data | name of | number of units sold | dollar amount |
| | best-selling item | | |

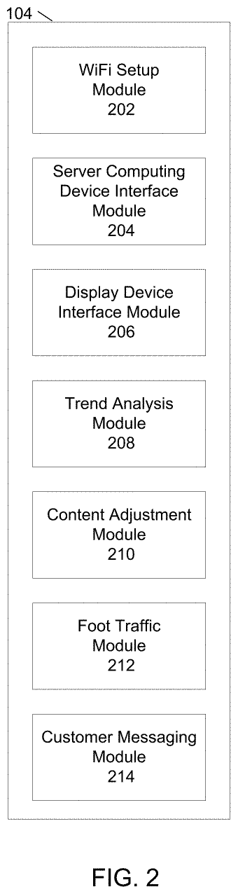

FIG. 2 shows example modules of dongle device 104. Dongle device 104 includes a WiFi setup module 202, a server computing device interface module 204, a display device interface module 206, a trend analysis module 208, a content adjustment module 210, a foot traffic module 212, and a customer messaging module 214. More, fewer, or different modules are possible.

The example WiFi setup module 202 permits dongle device 104 to be setup for a WiFi connection with server computing device 112. In an example implementation, mobile electronic computing device 102 establishes a Bluetooth connection with dongle device 104. Using a setup application on mobile electronic computing device 102, a wireless network can be selected, and a WiFi connection can be established between dongle device 104 and server computing device 112.

The example server computing device interface module 204, permits communication between dongle device 104 and server computing device 112 via the wireless connection. Menu board signage and statistical information can be transmitted from server computing device 112 to dongle device 104 via the wireless connection. Dongle device 104 can then organize and send the signage and information to display device 106.

The example display device interface module 206 includes a framework for rendering the signage for the menu board on display device 106. This includes rendering any published signage obtained from mobile electronic computing device 102 and rendering any dynamic changes to the signage based on processing of statistical information by trend analysis module 208 and content adjustment module 210.

The example trend analysis module 208 processes statistical information received via restaurant electronic computing device 110. The statistical information includes time/dated sales information regarding orders taken and items purchased using the electronic menu board. In an example implementation, restaurant electronic computing device 110 sends the statistical information to server computing device 112, and server computing device 112 sends the statistical information to dongle device 104. By processing the statistical information, trend analysis module 208 can identify purchasing trends, such as which items, if any, are more popular than others, which items may be slow-selling, which items, if any, are typically purchased together, which times of a day and week, if any, are most popular for purchasing certain items, whether there are any spikes or lulls in purchasing any items, and an impact on store inventory as a result of the items purchased.

The example content adjustment module 210 uses trend analysis data from trend analysis module 208 to dynamically determine whether any adjustments need to be made to the signage on the electronic menu board, and to dynamically have display device interface module 206 make the adjustments on display device 106. Example adjustments can include changing an order of a display of one or more menu items, highlighting one or more menu items, for example by flashing a name of a menu item to bring more attention to it, changing a color or font of a menu item, changing a price of a menu item, changing a graphic for a menu item, and changing or adding a video advertisement for a menu item. Other changes are possible. The changes can be made, for example, to emphasize a popular menu item, to advertise a menu item that may not be selling as well as expected, and promote a menu item by temporarily reducing the price of the menu item.

The example foot traffic module 212 permits system 100 to monitor customers having smartphones who enter the quick service restaurant. In an example implementation, when a customer having a smartphone enters the quick service restaurant, traffic module 212, via a Bluetooth signal, can detect the presence of the customer's smartphone. Traffic module 212 can then update a count of traffic in the quick service restaurant and periodically send the count of the traffic to trend analysis module 208 and to server computing device 112.

The example customer messaging module 214, when possible, identifies customers with smartphones who enter the quick service restaurant. Based on an identification, customer messaging module 214 can send a text message to the customer's smartphone. For example, the message can include a coupon for a particular food or beverage item that the customer is known to have ordered in the past. Other examples include sending a happy birthday message to the customer if it is determined that it is the customer's birthday, sending a welcome message to the customer, or sending a message for a promotion that can be tailored to the customer. Other examples are possible.

In an example implementation, the customer can sign-up in advance with the quick service restaurant and provide an identifier, for example a username, to the quick service restaurant. When the customer's smartphone is detected in the quick service restaurant a Bluetooth handshake with customer messaging module 214 can establish a connection with the customer's smartphone. When foot traffic module 212 detects the Bluetooth connection with the customer's smartphone, customer messaging module 214 can send a request to the customer's smartphone for the identifier. With the identifier, customer messaging module 214 can access a profile of the customer and determine what type of message to send to the customer.

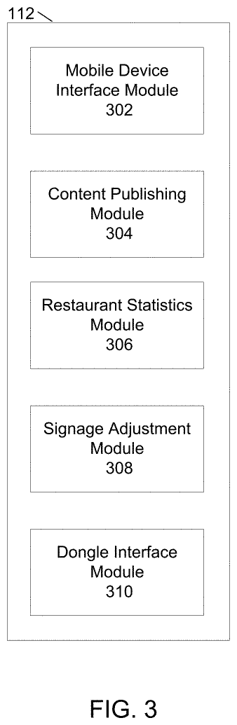

FIG. 3 shows example modules of server computing device 112. Server computing device 112 includes a mobile device interface module 302, a content publishing module 304, a restaurant statistics module 306, a signage adjustment module 308, and a dongle interface module 310. More, fewer, or different modules are possible.

The example mobile device interface module 302 receives menu board signage information from mobile electronic computing device 102. The menu board signage information includes electronic menu board content, graphics, videos, templates, location and other information for the electronic menu board entered into mobile electronic computing device 102. The menu board signage information can be stored on server computing device 112 or on database 114, can be published, as explained next herein, and can be sent to dongle device 104 for rendering on display device 106.

The example content publishing module 304 publishes the menu board signage information received by mobile device interface module 302. As used in this disclosure, publishing the signage information comprises making the stored signage information available to other server computing devices, which in turn can make the signage information available to other display devices.

The example restaurant statistics module 306 receives and processes statistics regarding sales and traffic at the quick service restaurant. In an example implementation, restaurant electronic computing device 110, which can be located in the quick service restaurant, or can be a server computer that processes sales and traffic data for the quick service restaurant, sends, or otherwise makes available, the sales and traffic data to server computing device 112. In some implementations, restaurant electronic computing device 110 and server computing device 112 can be the same device, so that, in this implementation, the quick service restaurant sends the sales and traffic data directly to server computing device 112.

In some implementations, restaurant statistics module 306 compiles the sales and traffic data for the quick service restaurant to dongle interface module 310 for transmittal to dongle device 104. In these implementations, dongle device 104 performs a trend analysis of the sales and traffic data, as discussed earlier, herein. In other implementations, restaurant statistics module 306 performs the trend analysis, and sends the results of the trend analysis to dongle interface module 310 for transmittal to dongle device 104.

The example signage adjustment module 308 processes information regarding changes to content for the electronic menu board and can provide dongle device 104 with information regarding the changes to the content, graphics, or videos. In an example implementation, restaurant electronic computing device 110 can include an advertising platform that can process the sales and traffic data for the quick service restaurant and dynamically suggest changes in advertising for the electronic menu board.

For example, the changes can comprise adding or substituting a video with an advertisement for a product that may be lagging in sales, or for which a promotion for the product may be advertised. As another example, the signage adjustment module 308 can suggest adjusting an order in which items are displayed, or highlighting a food item, for example by displaying a name of the food item in a bright color on the electronic menu board or by flashing the name on the electronic menu board. In another example, the signage adjustment module 308 can optimize signage based on customer profile information and a geographical location of the quick service restaurant. In some implementations, some or all of the functionality of signage adjustment module 308 can be included and performed on dongle device 104. Other examples are possible.

The example dongle interface module 310 communicates with dongle device 104 to send the electronic menu board signage information received from mobile device interface module 302 to dongle device 104. Dongle interface module 310 can also send the sales and traffic information processed by restaurant statistics module to dongle device 104. In addition, dongle interface module 310 can send advertising suggestions and signage adjustment information to dongle device 104.

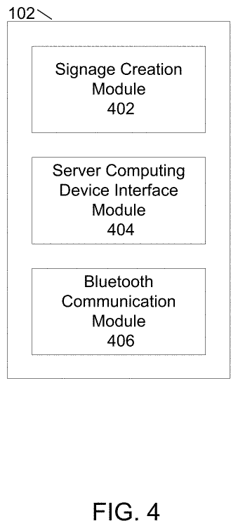

FIG. 4 shows example modules of mobile electronic computing device 102. Mobile electronic computing device includes a signage creation module 402, a server computing device interface module 404 and a Bluetooth communication module 406. More, fewer, or different modules are possible.

The example signage creation module 402 permits the signage for the electronic menu board to be created on mobile electronic computing device 102. In an example implementation, a software application for signage creation can be downloaded to mobile electronic computing device 102. For example, the software application can be downloaded from a web site that provides software applications for smartphones or the software application can be downloaded from a proprietary website. As discussed earlier herein, the software application permits an employee or owner of the quick service restaurant to create the signage.

The example server computing device interface module 204 establishes and maintains a wireless communication session between mobile electronic computing device 102 and server computing device 112. Mobile electronic computing device 102 can send the created signage to server computing device 112.

The example Bluetooth communication module 406 establishes a Bluetooth connection to dongle device 104, by which dongle device 104 is configured with WiFi connection credentials. The WiFi connection credentials can comprise authentication information, such as a user ID and password, that permit dongle device 104 to establish a wireless connection with server computing device 112.

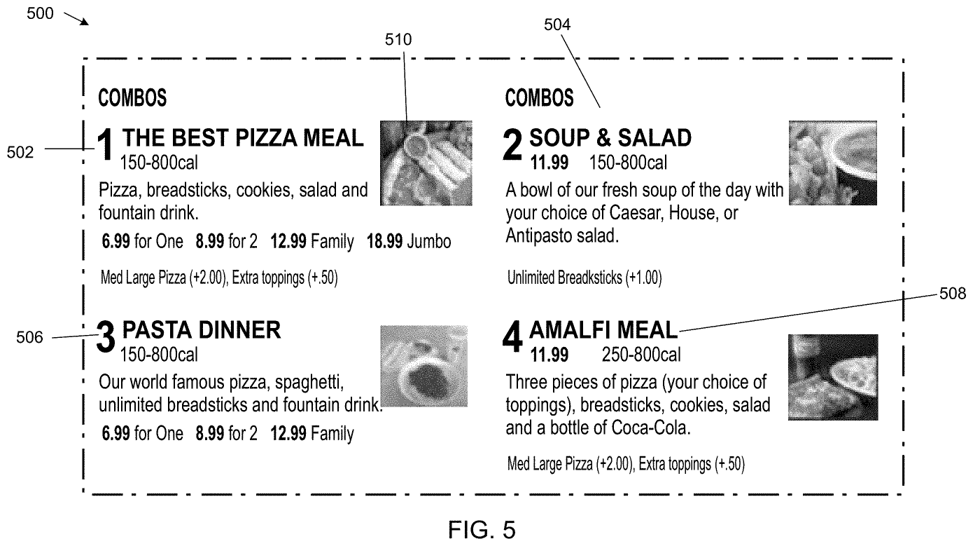

FIG. 5 shows an example display screen 500 for a first section of an example electronic menu board. The first section is displayed on a display device 106, in this case an electronic display screen. User interface screen 500 shows four example menu board items for combo meals. The example menu board items include menu items 502, 504, 506 and 508. Each of the menu board items includes example details for the menu item, such as a combo meal: a description of the meal, items included with the meal, such as cookies, salad and a fountain drink, a price for the meal and calories for the meal. Each menu board item also includes a graphic showing a photo of the menu item. For example, graphic 510 shows a graphic for the pizza meal illustrating the pizza associated with the menu item 502.

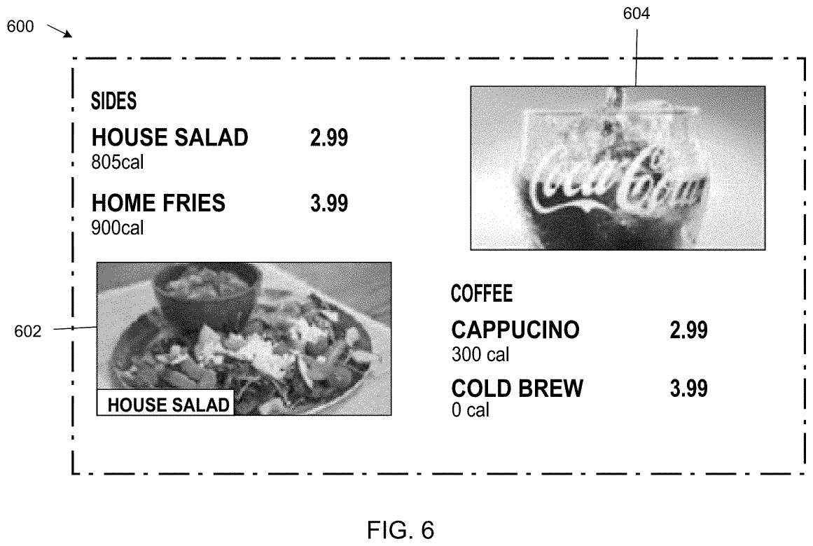

FIG. 6 shows an example display screen 600 for a second section of the example electronic menu board. The second section is displayed on another display device 106, a second electronic display screen. The example second section includes menu items for sides, including a house salad and home fries, and coffee, including cappuccino and cold brew. User interface screen 600 also includes a photo 602 of the house salad and a video 604 of the cold brew flowing onto a glass. Other graphics and videos can be shown on user interface screen 600, including advertisements. The advertisements can be both for menu items and non-menu items. For example, advertisements for products not listed on the electronic menu board can be displayed on any unused screen space on the electronic menu board.

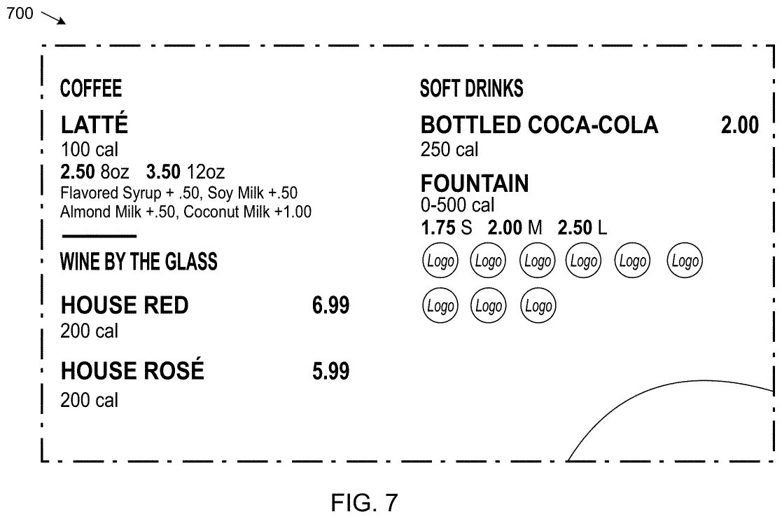

FIG. 7 shows an example display screen 700 for a third section of the example electronic menu board. The third section is displayed on yet another display device 106, a third electronic display screen. The third section includes descriptions for miscellaneous example menu board items, including latte, wind by the glass, and soft drinks.

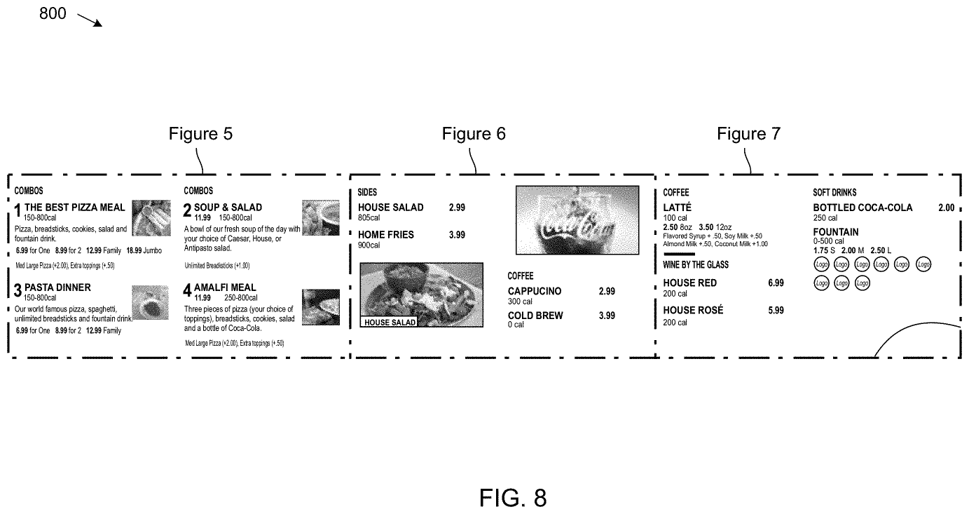

FIG. 8 shows an example display screen 800 for the entire electronic menu board including the first, second, and third sections. Display screen 800 is achieved by placing the display devices 106 for the first, second, and third section side by side.

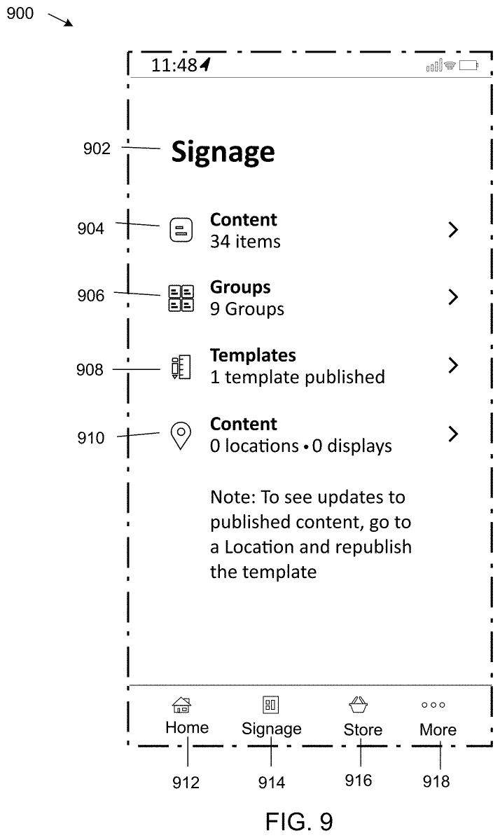

FIG. 9 shows an example user interface screen 900 for a software application for creating menu board content that can be activated on mobile electronic computing device 102. In an example implementation, user interface screen 900 can be rendered when a user, for example an employee or owner of the quick service restaurant, selects the software application on mobile electronic computing device 102 and enters authentication credentials, such as a user ID and password. User interface screen 900 includes a label 902 indicating signage, which, in this example includes content, group, template and location information. User interface screen 900 includes a content icon 904, a groups icon 906, a templates icon 908, locations icon 910, home icon 912, a signage icon 914, a store icon 916 and a more icon 918.

Selection of example content icon 904 activates a user interface screen 1000, discussed later herein, for adding content to the electronic menu board.

Selection of groups icon 906 permits organizing the added content into groups. Example groups can be combos, drinks, entrees, soft drinks, appetizers and desserts. The content is included in the selected group when displayed on the electronic menu board. For example, FIG. 5 shows combos, FIG. 6 shows sides and coffee, and FIG. 7 shows soft drinks and wine by the glass. Different or additional groups are possible.

Selection of templates icon 908 permits selection of a background style of the electronic menu board. Example background styles can be rustic (wood grain background), as shown in FIGS. 5-8, contemporary (marble background), classic (white background), and chalkboard (chalkboard background). Different or additional background styles are possible.

Selection of templates icon 908 permits selection of a template for organizing content on the electronic menu board. Examples templates can include a main menu template (with sections for entrees and desserts), and a segmented template (with sections for drinks, sandwiches, combos, desserts, and favorites). Different or additional templates are possible.

Selection of locations icon 910 permits entry of location information for the quick service restaurant. Location information can include a street address and a nickname for the quick service restaurant. Location information can also include hours of operation, including whether the quick service restaurant is open for breakfast, and starting and ending times for breakfast (if served), lunch and dinner. Different or additional location information is possible.

Selection of home icon 912, activates a home user interface screen, which can be a login screen. Activation of signage icon 914, activates user interface screen 900. Activation of store icon 916 activates a user interface screen listing any additional stores for which electronic menu board information can be added. Activation of more icon 918 can activate a user interface screen having miscellaneous content, such as access to profile information for the user and updates for the software application. In some implementations, more icon 918 is not used.

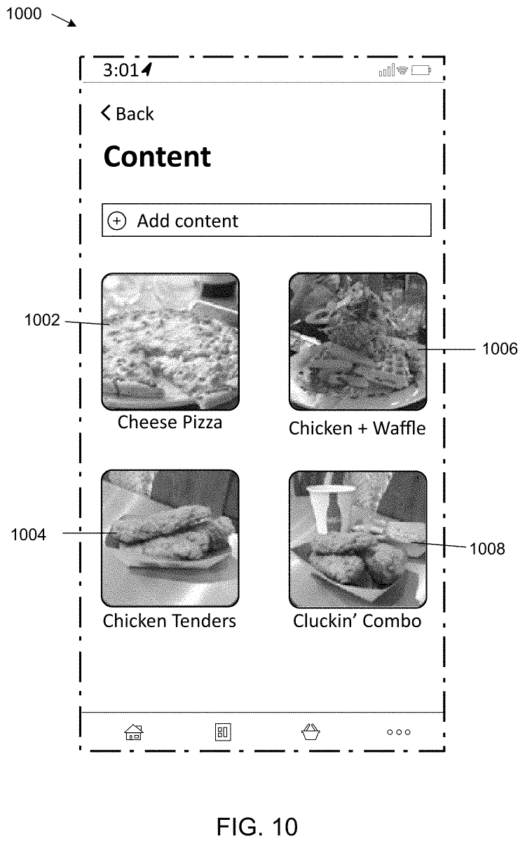

FIG. 10 shows an example user interface screen 1000 for adding content to the electronic menu board. As shown in FIG. 10, example content that can be added includes menu items for a cheese pizza 1002, chicken tenders 1004, chicken+waffle 1006, and a cluckin' combo 1008. Selection of any of these menu items can activate a user interface screen for editing content for the respective menu item.

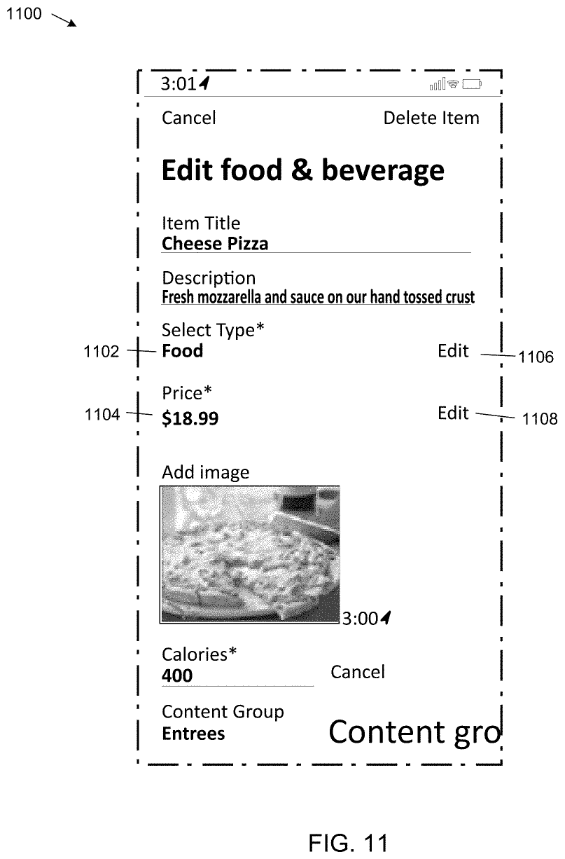

FIG. 11 shows an example user interface screen 1100 for editing content for food and beverage menu items. User interface screen is activated when the cheese pizza 1002 menu item of FIG. 10 is selected. As shown in example user interface screen 1100, for the cheese pizza 1002 menu item, there are two editable fields type 1102 and price 1104, and two edit activators 1106 and 1108, corresponding to the type 1102 and price 1104 editable fields, respectively. Selecting edit activator 1106 permits a selection to be made for the type either food or beverage. Selecting edit activator 1108 permits a selling price for the cheese pizza to be added or changed. Different edit fields are possible.

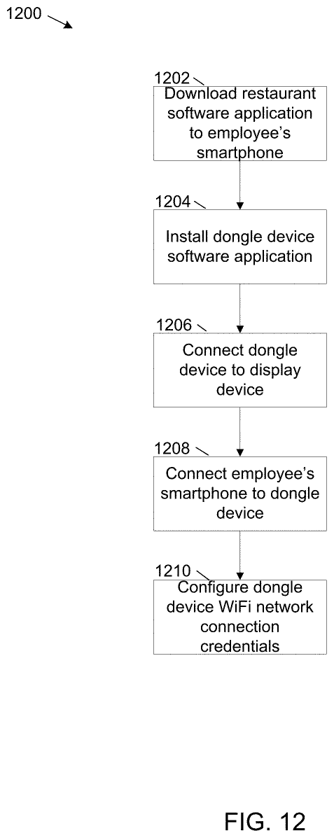

FIG. 12 shows a flowchart for an example method 1200 for setting up system 100 on mobile electronic computing device 102 and on dongle device 104. For method 1200, mobile electronic computing device 102 is referred to as a smartphone. For method 1200, the smartphone is operated by an employee or owner of a quick service restaurant, but is referred to as the employee's smartphone in the method. For method 1200, dongle device 104 is referred to as the dongle device.

At operation 1202, an electronic menu board software application for the quick service restaurant is downloaded to the employee's smartphone. The software application permits the employee to select and organize signage, including text, graphics, and video content, for the electronic menu board. In some implementations, the software application can be downloaded from an app store, for example from an IOS or Android app store. In other implementations, the software application can be downloaded from a website associated with the quick service restaurant. Other implementations are possible.

At operation 1204, a proprietary software application is installed on the dongle device. The proprietary software application includes software that can interface with a display device and organize electronic menu items on the display device. The proprietary software application can also include trend analysis software, which can analysis sales and other statistical data for the quick service restaurant and which can dynamically adjust the electronic menu board based on the trend analysis. The proprietary software application can also provide functionality for a short-range communication protocol, such as Bluetooth. For method 1200, the proprietary software application can be downloaded and installed on the dongle device from a server computing device, such as server computing device 112, that is associated with the quick service restaurant.

At operation 1206, the dongle device is physically connected to the display device. In some implementations, a connector on the dongle device can be physically inserted into a port on the display device, for example a USB port. In other implementations, the dongle device can be connected to the display device port via an extender cable. Other implementations are possible.

At operation 1208, a Bluetooth connection is made between the employee's smartphone and the dongle device. The connection permits communication between the software application on the employee's smartphone and the proprietary software application on the dongle device.

At operation 1210, the Bluetooth connection permits the employee, using the software application on the employee's smartphone, to configure WiFi network connection credentials on the dongle device. Configuring network WiFi credentials can comprise selecting a WiFi network, and configuring such items as a universal resource locator (URL) of the server computing device and login credentials, such a user ID and password for the server computing device. More, fewer, or different configuration credentials are possible.

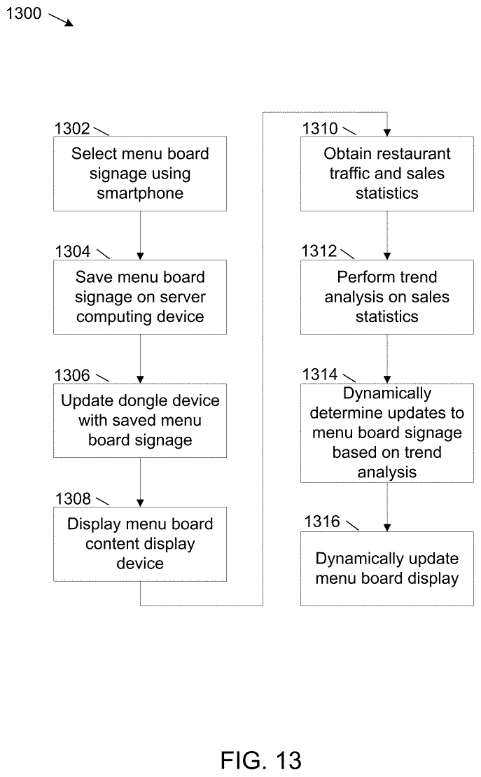

FIG. 13 shows a flowchart for an example method 1300 for using system 100 to create and dynamically update an electronic menu board on a display device. For method 1300, mobile electronic computing device 102 is referred to as the employee's smartphone, the employee being an employee or owner of a quick service restaurant, customer electronic computing device 116 is referred to as the customer's smartphone, the customer being a customer of the quick service restaurant, dongle device 104 is referred to as the dongle device, display device 106 is referred to as the display device, server computing device 112 is referred to as the server computing device, database 114 is referred to as the database, and restaurant electronic computing device 110 is referred to as the quick service restaurant electronic computing device.

At operation 1302, menu board signage is selected using the software application on the employee's smartphone. The menu board signage includes text and graphic content for menu items and can also include one or more videos. Selection is typically made via a graphical user interface (GUI) for the software application on the employee's smartphone. Using the GUI, as discussed earlier herein, content including menu items and prices for menu items can be selected. The content can be arranged into a specific order and organized into groups, such as entrée, drinks, and combos. Graphics and videos can be selected for certain menu items.

At operation 1304, a connection is made between the software application on the employee's smartphone and the server computing device. The selected menu board signage is then sent from the employee's smartphone to the server computer. The selected menu board signage is then stored at the server computer or on the database.

At operation 1306, the server computer, using the WiFi connection between the server computer and the dongle device, sends the selected menu board signage to the dongle device.

At operation 1308, the dongle device populates the selected menu board signage on the display device. The selected menu board signage can be populated on the display device using a menu framework contained in the proprietary software application on the dongle device or on the server computing device.

At operation 1310, statistics regarding sales volume and traffic in the quick service restaurant is obtained from the quick service restaurant electronic computing device. In some implementations, the statistics are sent from the quick service restaurant electronic computing device to the server computing device. In other implementations, the server computing device and the quick service restaurant electronic computing device can be the same physical device. The obtained statistics can comprise sales quantity and monetary amounts of each electronic menu board item. The statistics can also include a time of day that each menu item was sold, and summaries of items sold during a selected or predetermined time interval, such as daily, hourly, half-hourly, and quarter-hourly. Other or different time intervals are possible.

Foot traffic in the quick service restaurant can be derived from the statistics. In some implementations, for example when a customer has a smartphone with Bluetooth functionality turned on, foot traffic can also be derived from communication between the customer's smartphone and the dongle device.

At operation 1312, a trend analysis is performed on the sales statistics. The trend analysis can determine which items are selling well, which items are selling below expectations, when peak sales or spikes in sales occur, when there are lull periods for sales, and other trends. In some implementations, the trend analysis is performed on the dongle device. In other implementations, the trend analysis is performed on the server computing device.

At operation 1314, updates to the menu board signage are dynamically determined based on the trend analysis. The updates can comprise adding or deleting a menu item, changing an order of items listed, highlighting one or more items, adding or changing a graphic associated with a menu item, substituting or adding a video for a menu item, and substituting or adding an advertisement for a menu item. Other updates are possible.

At operation 1316, the dongle device dynamically updates the electronic menu board based on the updates determined by the trend analysis. The dongle device can also update the electronic menu board based on any specific changes to menu board items sent from the server computer. For example, when the employee manually changes the signage or prices using the software application on the employee's smartphone, and sends the changes to the server computer, the server computer can update the dongle device with the changes, and the dongle device can update the electronic menu board with the changes.

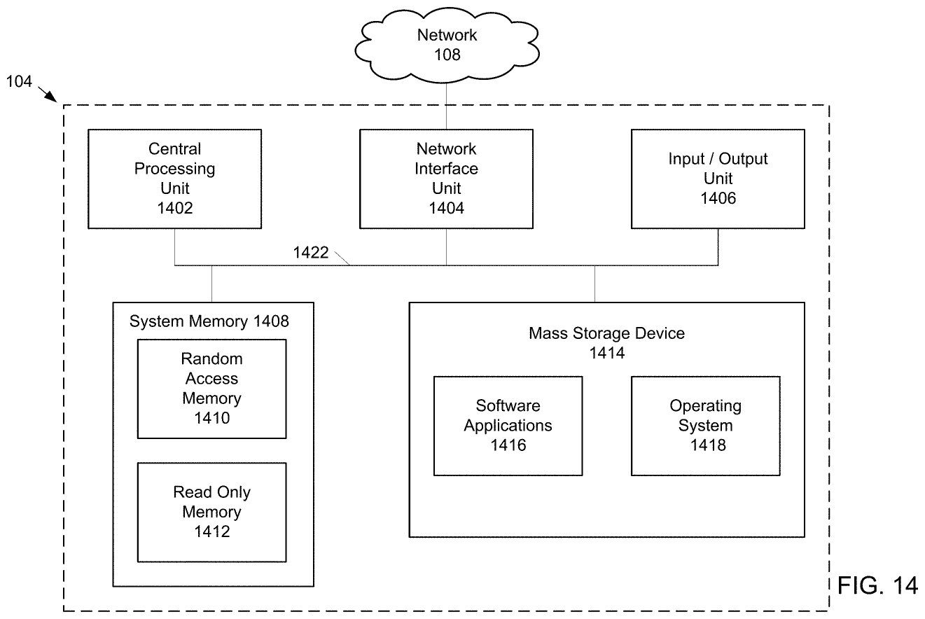

As illustrated in the example of FIG. 14, dongle device 104 includes at least one central processing unit (“CPU”) 1402, also referred to as a processor, a system memory 1408, and a system bus 1422 that couples the system memory 1408 to the CPU 1402. The system memory 1408 includes a random access memory (“RAM”) 1410 and a read-only memory (“ROM”) 1412. A basic input/output system that contains the basic routines that help to transfer information between elements within the dongle device 104, such as during startup, is stored in the ROM 1412. The dongle device 104 further includes a mass storage device 1414. The mass storage device 1414 is able to store software instructions and data. Some or all of the components of the dongle device 104 can also be included in mobile electronic computing device 102, customer electronic computing device 116, server computing device 112, and restaurant electronic computing device 110.

The mass storage device 1414 is connected to the CPU 1402 through a mass storage controller (not shown) connected to the system bus 1422. The mass storage device 1414 and its associated computer-readable data storage media provide non-volatile, non-transitory storage for the dongle device 104. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the dongle device 104 can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the dongle device 104.

According to various embodiments of the invention, the dongle device 104 may operate in a networked environment using logical connections to remote network devices through the network 108, such as a wireless network, the Internet, or another type of network. The dongle device 104 may connect to the network 108 through a network interface unit 1404 connected to the system bus 1422. It should be appreciated that the network interface unit 1404 may also be utilized to connect to other types of networks and remote computing systems. The dongle device 104 also includes an input/output controller 1406 for receiving and processing input from a number of other devices, including a touch user interface display screen, or another type of input device. Similarly, the input/output controller 1406 may provide output to a touch user interface display screen or other type of output device.

As mentioned briefly above, the mass storage device 1414 and the RAM 1410 of the dongle device 104 can store software instructions and data. The software instructions include an operating system 1418 suitable for controlling the operation of the dongle device 104. The mass storage device 1414 and/or the RAM 1410 also store software instructions and software applications 1416, that when executed by the CPU 1402, cause the dongle device 104 to provide the functionality of the dongle device 104 discussed in this document. For example, the mass storage device 1414 and/or the RAM 1410 can store software instructions that, when executed by the CPU 1402, cause the dongle device 104 to display received data on the display screen of the display device 106.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method implemented on a dongle device for controlling menu board items on an attached display device, the method comprising:
on the dongle device, receiving content for a menu board from an electronic computing device;
transferring the menu board content to the display device for display on the display device;
receiving information regarding sales of items listed on the menu board, the information identifying purchasing trends for the items listed on the menu board; and
dynamically updating a display of the menu board items based on the identified purchasing trends.

2. The method of claim 1, further comprising dynamically updating the display of the menu board items based on the identified purchasing trends, and a geographical location of the dongle device.

3. The method of claim 1, wherein the information regarding the sales of items listed on the menu board comprises a quantity of each item purchased via the menu board and a monetary amount of each item purchased.

4. The method of claim 3, wherein the information regarding the sales of the items listed on the menu board further comprises a date and time for which each item was purchased.

5. The method of claim 3, wherein the information regarding the sales of the items listed on the menu board further comprises a summary of sales volume delineated by time and hour.

6. The method of claim 1, further comprising receiving from the electronic computing device information regarding advertisements to be displayed on the menu board.

7. The method of claim 6, wherein the information regarding the advertisements comprises one or more specific videos or graphics to be displayed on the menu board.

8. The method of claim 6, wherein the information regarding the advertisements includes placement positions for the one or more specific videos or graphics to be displayed on the menu board.

9. The method of claim 1, wherein dynamically updating the display of the menu board comprises re-arranging an order of one of more items displayed on the menu board, based on the identified purchasing trends.

10. The method of claim 1, wherein dynamically updating the display of the menu board comprises highlighting one or more of the items displayed on the menu board based on the identified purchasing trends.

11. The method of claim 10, wherein the highlighting comprises flashing of changing a color or a font for one or more of the items displayed on the menu board based on the identified purchasing trends.

12. The method of claim 1, further comprising monitoring traffic of customers who enter a geographical location where the dongle device is located.

13. The method of claim 12, wherein a communication is received at the dongle device from each of the customers via a short-distance wireless communication protocol.

14. A dongle device comprising:
a processor; and
system memory, the system memory including instructions which, when executed by the processor, cause the dongle device to:
receive signage for an electronic menu board from a server computer, the signage including textual and graphic content, the electronic menu board being operational in a restaurant;
transfer the signage to a display device attached to the dongle device for display on the display device;
receive statistical data regarding sales of the items listed on the electronic menu board;
identify purchasing trends from the statistical data regarding the sales of the items listed on the electronic menu board;
receive a geographical location of the restaurant; and
dynamically update a display of the electronic menu board items based on the identified purchasing trends and the geographical location of the restaurant.

15. The dongle device of claim 14, wherein the statistical data comprises a number of units sold and a monetary value of sales for each item listed on the electronic menu board for a specified time period.

16. The dongle device of claim 14, wherein dynamically update the display of the electronic menu board items comprises highlighting a popular item on the electronic menu board.

17. The dongle device of claim 14, wherein dynamically update the display of the electronic menu board items comprises adding a video advertisement for a menu item for which sales are below expectations.

18. The dongle device of claim 14, wherein the instructions further cause the dongle device to monitor traffic of customers who enter the restaurant.

19. The dongle device of claim 18, wherein a communication is received at the dongle device from each of the customers via a Bluetooth transmission from a mobile electronic computing device of each respective monitored customer.

20. A dongle device comprising:
a processor; and
system memory, the system memory including instructions which, when executed by the processor, cause the dongle device to:
receive signage for an electronic menu board from a server computer, the signage including textual, graphic, and video content, the electronic menu board being operational in a quick service restaurant;
transfer the signage to a display device attached to the dongle device for display on the display device;
receive, from the server computer, statistical data regarding sales of the items listed on the electronic menu board, the statistical data including a number of units sold and a monetary amount of sales by day and hour for each item listed on the electronic menu board;
identify purchasing trends from the statistical data regarding the sales of the items listed on the electronic menu board, the purchasing trends identifying best-selling items, slowest-selling items, spikes in purchasing, and lulls in purchasing;
receive from the server computer an advertisement for a slow-selling item;
receive a geographical location of the restaurant; and
dynamically update a display of the electronic menu board items based on the identified purchasing trends and the geographical location of the quick service restaurant, including adding to the electronic menu board the advertisement for the slow-selling item.
